(19) United States
(12) Patent Application Publication
(10) Pub. No.: US 2005/0146187 A1
(43) Pub. Date: Jul. 7, 2005

(54) Manual seat back recliner mechanism

(76) Inventors: Otto John Volker, Rochelle, IL (US); Billy Lee Larson, Elizabeth, IL (US); Nathan Denton Lewin, Oregon, IL (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 10/742,056

(22) Filed: Dec. 18, 2003

(51) Int. Cl. B60N 2/235; B60N 2/22

(52) U.S. Cl. 297/369; 297/367

(57) ABSTRACT

A recliner mechanism includes a base housing adapted to be held to a seat cushion frame and a sector housing adapted to be held to a seat back frame. The sector housing is rotatable about a pivot axis and has a plurality of teeth. A locking pawl has a plurality of teeth engageable with the teeth of the sector housing. The locking pawl is movable between a locking position with the locking pawl teeth engaging the sector teeth to prevent rotation of the sector housing and a releasing position with the locking pawl teeth disengaged from the sector teeth to permit rotation of the sector housing. A cam is rotatable about the pivot axis and is rotatably connected to the locking pawl about an eccentric axis to move the locking pawl between the locking position and the releasing position in response to rotation of the cam about the pivot axis.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a recliner mechanism for a seat, and more particularly, a recliner mechanism for adjusting an inclination angle of a seat back with respect to a seat cushion of a motor vehicle seat.

### BACKGROUND OF THE INVENTION

Recliner mechanisms are utilized with seats to enable an angular position of a seat back portion to be adjusted relative to an associated seat cushion portion. A seat occupant can adjust the angle of the seat back to a position which provides the most comfort to the occupant. Recliner mechanisms typically have a pawl/sector-type lock which when released allows the seat back to pivot but when locked prevents the seat back from pivoting. For example, see U.S. Pat. No. 4,076,309, the disclosure of which is expressly incorporated herein in its entirety by reference. The lock typically has an internal sector gear in order to provide a relatively small overall package size for the recliner mechanism.

While prior recliner mechanisms may adequately permit adjustment of the seat back, there is a continuing desire to provide finer adjustment. Attempts to provide finer adjustment have resulted in external gear sectors which in turn results in increased overall package sizes. Accordingly, there is a need in the art for an improved recliner mechanism which provides fine adjustment while utilizing an internal gear sector and/or not increasing the overall package size.

### SUMMARY OF THE INVENTION

The present invention provides a seat-back recliner mechanism which overcomes at least some of the above-noted problems of the related art. According to the present invention, a recliner mechanism includes, in combination, a base housing adapted to be held to a seat cushion frame and a sector housing adapted to be held to a seat back frame. The sector housing is rotatable relative to the base housing about a pivot axis and has a plurality of teeth. The locking pawl has a plurality of teeth engageable with the teeth of the sector housing. The locking pawl is movable between a locking position with the teeth of the locking pawl engaging the teeth of the sector housing to prevent rotatable movement of the sector housing relative to the base housing and a releasing position with the teeth of the locking pawl disengaged from the teeth of the sector housing to permit rotatable movement of the sector housing relative to the base housing. A cam is rotatable about the pivot axis and is rotatably connected to the locking pawl about an eccentric axis to move the locking pawl between the locking position and the releasing position in response to rotation of the cam about the pivot axis.

According to another aspect of the present invention, a recliner mechanism includes, in combination, a base housing adapted to be held to a seat cushion frame and a sector housing adapted to be held to a seat back frame. The sector housing is rotatable relative to the base housing about a pivot axis and has a plurality of teeth. The locking pawl has a plurality of teeth engageable with the teeth of the sector housing. The locking pawl is movable between a locking position with the teeth of the locking pawl engaging the teeth of the sector housing to prevent rotatable movement of the sector housing relative to the base housing and a releasing position with the teeth of the locking pawl disengaged from the teeth of the sector housing to permit rotatable movement of the sector housing relative to the base housing. A cam is rotatable about the pivot axis and is operably connected to the locking pawl to move the locking pawl between the locking position and the releasing position in response to rotation of the cam about the pivot axis. The cam moves a lateral axis of the locking pawl along an arc about the pivot axis.

According to yet another aspect of the present invention, a recliner mechanism, in combination, a base housing adapted to be held to a seat cushion frame and a sector housing adapted to be held to a seat back frame. The sector housing is rotatable relative to the base housing about a pivot axis and has a plurality of teeth. A locking pawl has a plurality of teeth engageable with the teeth of the sector housing. The locking pawl is movable between a locking position with the teeth of the locking pawl engaging the teeth of the sector housing to prevent rotatable movement of the sector housing relative to the base housing and a releasing position with the teeth of the locking pawl disengaged from the teeth of the sector housing to permit rotatable movement of the sector housing relative to the base housing. A cam is rotatable about the pivot axis and operably connected to the locking pawl to move the locking pawl between the locking position and the releasing position in response to rotation of the cam about the pivot axis. The base housing is provided with a boss located about the pivot axis. The cam is provided with a recess closely receiving the boss to transfer loads from the cam to the base housing.

From the foregoing disclosure and the following more detailed description of various preferred embodiments it will be apparent to those skilled in the art that the present invention provides a significant advance in the technology of seat back recliner mechanisms. Particularly significant in this regard is the potential the invention affords for providing a high load bearing, high quality, feature-rich, finely adjusted, reduced part number, low cost assembly. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a inner/bottom perspective view of a seat back recliner mechanism according a preferred embodiment of the present invention;

FIG. 2 is an outer/bottom perspective view of the seat back recliner mechanism of FIG. 1;

FIG. 3 is an outer elevational view of the seat back recliner mechanism of FIGS. 1 and 2 wherein the mechanism is in a locked condition;

FIG. 4 is an inner elevational view of the seat back recliner mechanism of FIG. 3 wherein components are removed for clarity;

FIG. 5 is an outer elevational view of the seat back recliner mechanism of FIGS. 1 to 4 wherein the mechanism is in a released condition; and

FIG. 6 is an inner elevational view of the seat back recliner mechanism of FIG. 5 wherein components are removed for clarity.

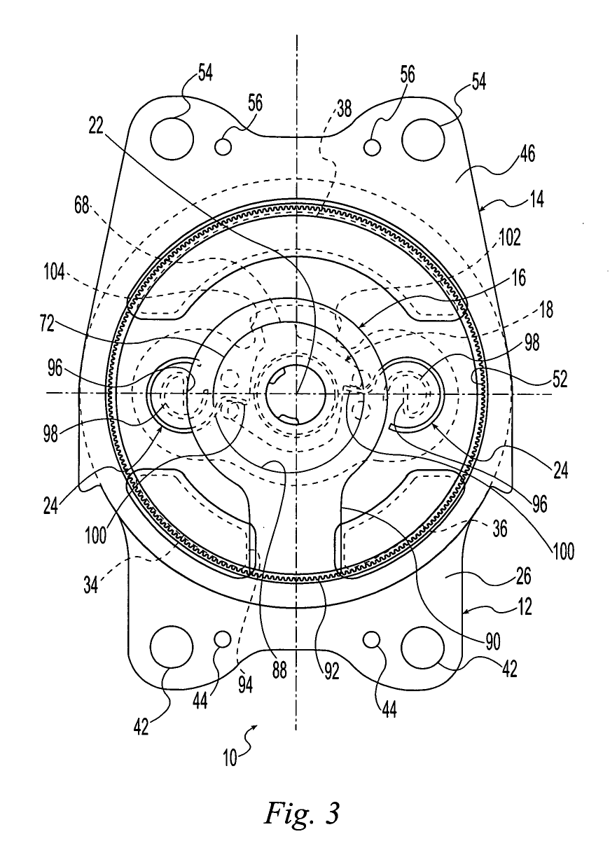

It should be understood that the appended drawings are not necessarily to scale, presenting a somewhat simplified representation of various preferred features illustrative of the basic principles of the invention. The specific design features of the recliner mechanism as disclosed herein, including, for example, specific dimensions, orientations, and shapes of the cam and locking pawl. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the recliner mechanism illustrated in the drawings. In general, up or upward refers to an upward direction generally in the plane of the paper in FIG. 3 and down or downward refers to a downward direction generally in the plane of the paper in FIG. 3. Also in general, fore or forward refers to a direction toward the front of the motor vehicle and aft or rearward refers to a direction toward the rear of the motor vehicle. Furthermore, in general, lateral refers to a direction side to side of the motor vehicle and a direction into and out of the paper in FIG. 3.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved recliner mechanism disclosed herein. The following detailed discussion of various alternative and preferred embodiments will illustrate the general principles of the invention with reference to a motor vehicle seat. Other embodiments suitable for other applications will be apparent to those skilled in the art given the benefit of this disclosure.

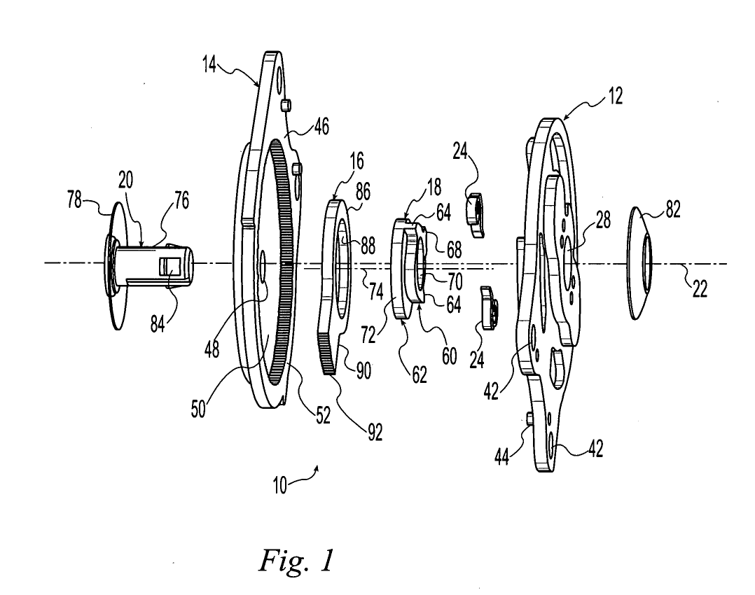

Referring now to the drawings, FIGS. 1 to 4 show a manual seat back recliner mechanism 10 for a seat of a motor vehicle, such as an automobile, according to a preferred embodiment of the present invention. While the illustrated embodiments of the present invention are particularly adapted for use with an automobile, it is noted that the present invention can be utilized with any motor vehicle having a control cable including trucks, buses, vans, recreational vehicles, earth moving equipment and the like, off road vehicles such as dune buggies and the like, air borne vehicles, and water borne vehicles.

The illustrated recliner mechanism 10 includes an inner or lower arm or base housing 12, an outer or upper arm or sector housing 14 selectively pivotable relative to the base housing 12, a locking pawl 16 movable between a locking position which locks the sector housing 14 against rotation relative to the base housing 12 and a releasing position which permits the sector housing 14 to rotate relative to the base housing 12, an eccentric cam 18 which forms an eccentric pivotable connection with the locking pawl 16 for moving the locking pawl 16 between the locking and releasing positions, a cam shaft or pin 20 which forms a central or pivot axis 22 for the eccentric cam 18 coaxial with the seat back pivot axis, and spring members 24 for biasing the locking pawl 16 into the locking position.

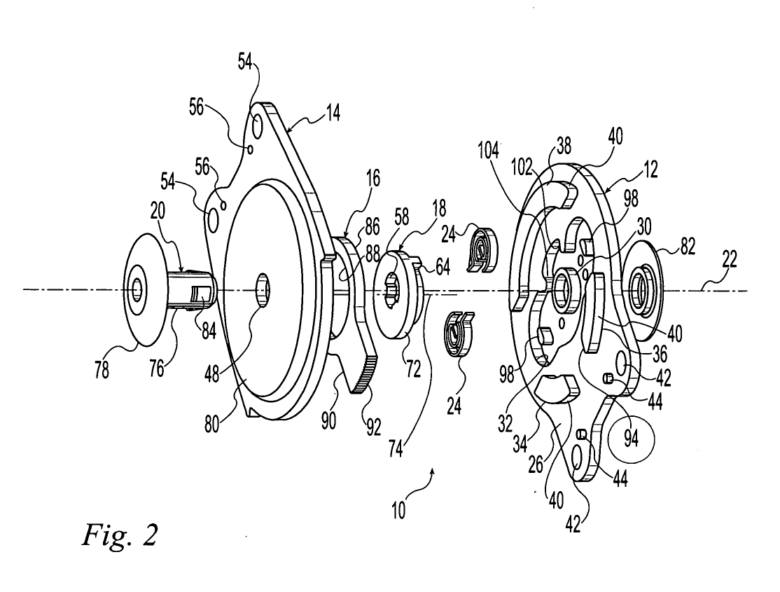

As best shown in FIGS. 1 and 2, the illustrated base housing 12 has a generally planar first face or surface 26 facing the sector housing 14. The laterally extending central axis 22 is coaxial with a laterally extending pivot axis of the seat back when the recliner mechanism is installed on the vehicle seat. An opening 28 is formed at the central axis 22 sized and shaped for receiving the cam pin 20 as described in more detail hereinafter. A cylindrically shaped boss 30 outwardly extends from the base housing 12 about the opening 28. The boss 30 is sized and shaped to cooperate with the cam 18 as described in more detail hereinafter. The opening 28 and the boss 30 are located in a recess 32 formed in the first surface 26. The illustrated boss 30 is shaped as a circular tube but other suitable shapes can be utilized. The recess 32 is sized and shaped for cooperating with the cam 18 and the spring members 24 as described in more detail hereinafter. Outwardly extending from the first surface 26 are a plurality of pads or guides 34, 36, 38 sized and shaped for cooperating with the sector housing 14 as described in more detail hereinafter. The pads 34, 36, 38 cooperate to form a radially outward facing cylindrically shaped guide surface 40 for the sector housing 14. It is noted that a lesser or greater number of pads 34, 36, 38 can be utilized. The lower end of the base housing 12 is provided with fastener openings 42 and alignment pins 44 for attachment and positioning of the base housing 12 to the cushion or base portion of the vehicle seat. The base housing 12 can be formed of any suitable material such as a plastic or metal.

The illustrated sector housing 14 has a generally planar first face or surface 46 facing the base housing 12. The sector housing 14 shares the laterally extending central axis 22 with the base housing 12. An opening 48 is formed at the central axis 22 sized and shaped for receiving the cam pin 20 as described in more detail hereinafter. The opening 8 is located in a recess 50 formed in the first surface 46. The recess 50 is sized and shaped for receiving the pads 34, 36, 38 closely therein such that the sector housing 14 is pivotable relative to the base housing about the central axis 22 as described in more detail hereinafter. The recess 50 forms a radially inward facing cylindrical surface having a plurality of internal teeth 52 formed therein. The teeth 52 are sized and shaped to cooperate with the locking pawl 16 as described in more detail herein after. The illustrated plurality of teeth 52 extend entirely about the central axis 22 and are spaced at intervals of about 1.5 degrees. It is noted that the sector housing 14 can alternatively have teeth 52 over a smaller portion or sector and can alternatively have larger (resulting in grosser adjustment) or smaller (resulting in finer adjustment) spacing between centerlines of the teeth 52. The upper end of the sector housing 14 is provided with fastener openings 54 and alignment pins 56 for attachment and positioning of the sector housing 14 to the seat-back portion of the vehicle seat. The sector housing 14 can be formed of any suitable material such as a plastic or metal.

The illustrated eccentric cam 18 has an opening 58 sized and shaped for receiving the cam pin 20 therethrough. The cam 18 has first and second axial portions 60, 62. The first axial portion 60 is sized and shaped to be located within the recess 32 of the base housing 12 while the second axial portion 62 is sized and shaped to be located within the recess 50 of the sector housing 14. The first axial portion 60 has radially extending arms or wings 64 on opposite sides which form abutments 66 cooperating with the spring members 24 as described in more detail hereinafter. The illustrated first axial portion 60 also has a radially extending leg 68 at the top which is sized and shaped to cooperate with the base housing 12 to form a mechanical stop as described in more detail hereinafter. The first axial portion 60 is preferably provided with a cylindrically-shaped recess 70 about the opening 58 which is sized and shaped to closely receive the boss 30 of the base housing 12 therein. The recess 70 and the boss 30 are preferably sized and shaped to transfer loads from the cam 18 to the base housing 12. The second axial portion 62 forms an eccentric cam surface 72. The illustrated cam surface is a radially outward facing cylindrically shaped surface having an eccentric axis 74 parallel to and offset from the central axis 22. The cam surface 72 is sized and shaped to cooperate with the locking pawl 16 as described in more detail hereinbelow.

The illustrated cam pin 20 has a cylindrically shaped body portion 76 extending along the central axis 22 and a radially enlarged head 78 at one end. The body portion 76 is sized and shaped to closely extend through the openings 28, 48, 58 in the base housing 12, the eccentric cam 18, and the sector housing 14 with the head 78 engaging a second or outer face or surface 80 of the sector housing 14. A retainer 82 is provided on the free end of the cam pin 20 to retain the cam pin 20 in the openings 28, 48, 58 and to hold the mechanism components together. The illustrated cam pin 20 is provided with resiliently deflectable wings or protrusions 84 that form a releasable snap-lock connection with the retainer 82. It is noted that the cam pin 20 and/or retainer 82 can alternatively take any other suitable form. The cam pin 20 and the eccentric cam 18 are preferably provided with cooperating keys or flats for forming a positive mechanical engagement between the components so that they pivot together about the central axis 22. The outer end of the cam pin 20 is adapted for attachment of a handle or drive so that the cam pin 20 can be selectively pivoted or rotated about the central axis 22 by the operator. With the cam pin 20 extending through the openings 28, 48, 58, the cam pin 20 and the eccentric cam 18 are pivotable about the central axis 22 relative to the base housing 12. It is noted that the sector housing 14 is also pivotable relative to the base housing 12 as described in more detail hereinbelow.

The illustrated locking pawl 16 has a generally disk-shaped main portion 86 having an opening 88 formed therein. The opening 88 is sized and shaped for closely receiving the eccentric cam surface 72 therein so that the locking pawl 16 is located in the recess 50 of the sector housing 14 eccentric of the central axis 22. A leg 90 extends from a lower side of the main portion 86 and has a plurality of external teeth 92 formed along an arc at a lower end. The teeth 92 are sized and shaped to cooperate with the teeth 52 of the sector housing 14 to lock the sector housing 14 against pivotable movement relative to the base housing 12. The leg 90 extends to the sector housing teeth 52 through an opening 94 located between the lower pads or guides 34, 36 of the base housing 12. The lower guides 34, 36 are sized and shaped to guide the locking pawl 16 over a desired path as described in more detail hereinbelow.

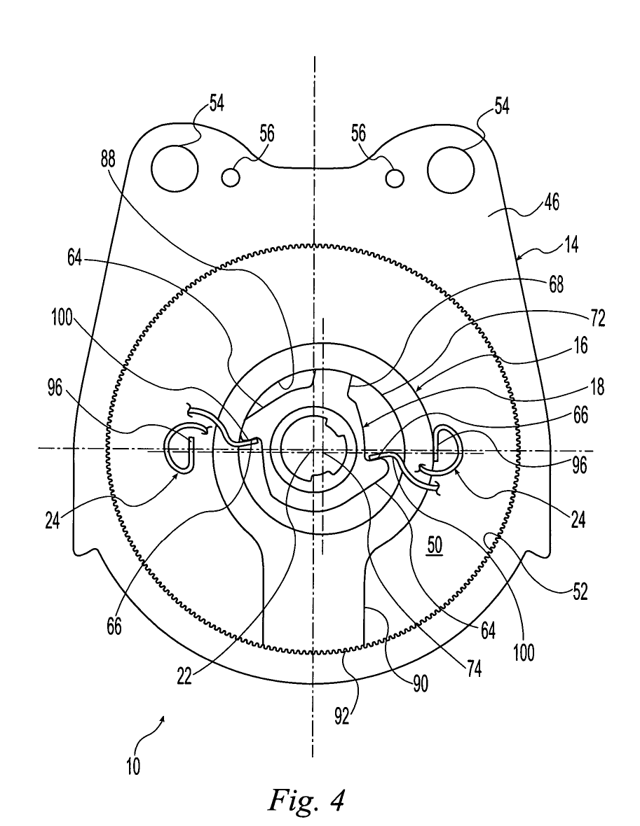

The illustrated spring members 24 are coiled wire torsion springs. As best shown in FIGS. 3 and 4, the spring members 24 as are located within the recess 32 of the base housing 12 on opposite sides of the boss 30. One free end 96 of the spring members 24 engage protrusions 98 formed in the recess 32 of the base housing 12 on opposite sides of the boss 30. The other free end 100 of the spring members 24 engage the abutments 66 formed by the wings 64 of the eccentric cam 18. Formed in this manner, the spring members 24 each bias the eccentric cam 18 to rotate in the same direction to move the locking pawl 16 to the locking position. In the illustrated embodiment, the spring members 24 bias the eccentric cam 18 in a counterclockwise direction as viewed in FIG. 3 and a clockwise direction as viewed in FIG. 4. It is noted that while the illustrated embodiment utilizes torsion springs, any other suitable type of spring members 24 can be utilized. It is also noted that while the illustrated embodiment utilizes two spring members 24, a greater or lesser number of spring members 24 can be utilized.

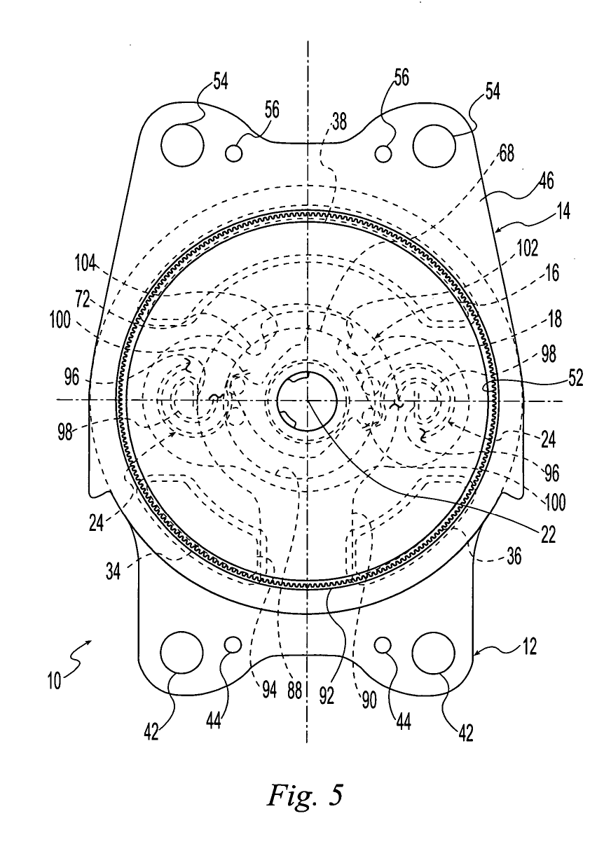

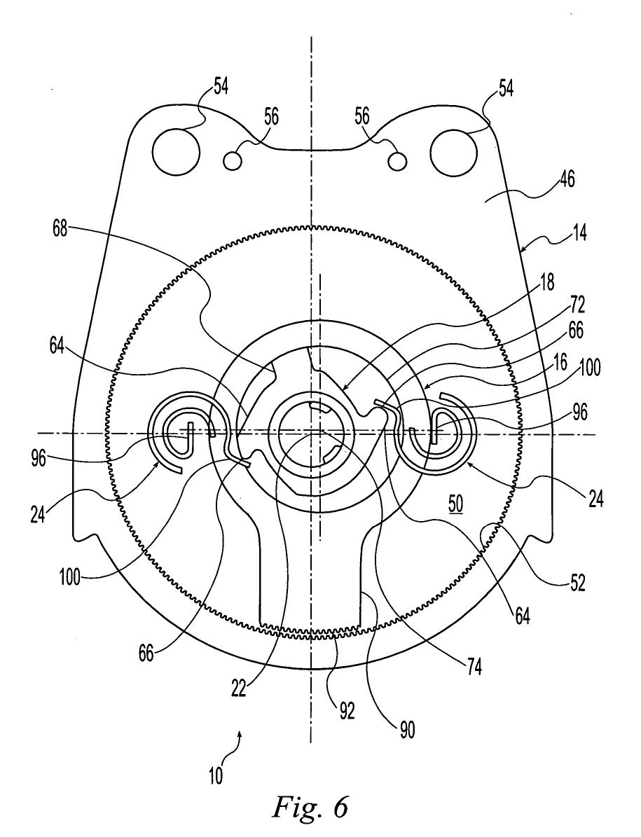

As best shown in FIGS. 3 and 4, the spring members 24 bias the eccentric cam 18 so that the eccentric cam 18 downwardly positions the locking pawl 16 in the locking position, wherein the teeth 92 of the locking pawl 16 engage the teeth 52 of the sector housing 14 to prevent pivoting of the sector housing 14 relative to the base housing 12. The locking position of the locking pawl 16 thus prevents the seat back from pivoting relative to the seat cushion. When it is desired to adjust the inclination of the seat back relative to the seat cushion, the operator turns the handle secured to the cam pin 20 to rotate the cam pin 20 against the bias of the spring members 24. As best seen in FIGS. 5 and 6, rotation of the cam pin 20 about the central axis 22 rotates the eccentric cam 18 (in a clockwise direction as seen in FIG. 5 and a counter-clockwise direction as seen in FIG. 6) about the central axis 22. Rotation of the eccentric cam 18 moves the locking pawl 16 to the releasing or unlocking position, wherein the teeth 92 of the locking pawl 16 are disengaged from the teeth 52 of the sector housing 14 to permit pivoting of the sector housing 14 relative to the base housing 12. The releasing position of the locking pawl 16 thus permits the seat back to pivot relative to the seat cushion so that the operator may position the seat back to a desired inclination. When the seat back is at the desired location, the operator releases the handle and the spring members 24 resiliently rotate the eccentric cam 18 about the central axis 2 to return the locking pawl 16 to the locking position.

The eccentric pivotable connection between the cam 18 and the locking pawl 16 causes the locking pawl 16 to move in a “cam-shaft” manner upon rotation of the eccentric cam 18. Because the eccentric axis 74 of the cam surface 72 and the locking pawl 16 is spaced apart from the central axis 22 of the cam pin 20 which is the rotational axis of the cam 18, the eccentric axis 74 of the cam surface 72 and the locking pawl 16 rotates about the central axis 22 of the cam pin upon rotation of the cam 18 (best seen in FIGS. 4 and 6) about the central axis 22. The eccentric cam 18 provides movement of the locking pawl 16 in a manner which permits the teeth 52, 92 to have smaller spacing than prior art designs and thus the recliner mechanism 10 according to the present invention provides finer adjustment of the seat back inclination.

In the illustrated embodiment, the eccentric cam 18 is rotated about 30 degrees to move the locking pawl 16 from the locking position (FIGS. 3 and 4) to the releasing position (FIGS. 5 and 6). It is noted that the mechanism 10 can be alternatively designed to have a lesser or greater angle of release rotation. The illustrated upper pad guide 38 of the base housing 12 forms a mechanical stop or abutment 102 for the cam leg 68 to prevent over rotation of the recliner mechanism 10. The stop 102 is engaged by the cam leg 68 when the cam 18 is rotated more than required to move the locking pawl 16 from the locking position to the releasing position. The illustrated stop 102 is engaged when the cam 18 is rotated about 35 degrees but other suitable positions for the stop 102 can alternatively be utilized. The illustrated embodiment includes a second stop 104 which is the mirror image of the stop 102 and is not used during the operation of the illustrated embodiment because the engagement of the locking pawl teeth 92 with the sector teeth 52 will not permit the cam leg 68 to be rotated into engagement with the second stop 104. The second stop 104 is preferably provided so that the base housing 12 can be universally used for both left and right hand recliner mechanisms 10. With the illustrated left-hand recliner mechanism 10, the first stop 102 is utilized but in an alternative right-hand recliner mechanism the motion is reversed and the second stop 104 is utilized. It is noted that when left and right hand recliner mechanisms 10 are utilized on opposite sides of the same vehicle seat, the recliner mechanisms 10 are preferably connected by connecting rods to synchronize movement of the two recliner mechanisms 10.

It should be appreciated from the above detailed description that the recliner mechanism 10 according to the present invention provides improved locking pawl 16 movement which results in refined adjustment of the seat back while maintaining a small overall package size. The connection between the cam 18 and the base housing 12 also provides improved translation of load from the cam 18 to the base housing 12 so that the mechanism 10 can withstand higher loads.

From the foregoing disclosure and detailed description of certain preferred embodiments, it will be apparent that various modifications, additions and other alternative embodiments are possible without departing from the true scope and spirit of the present invention. For example, it will be apparent to those skilled in the art, given the benefit of the present disclosure, that the eccentric cam 18 and locking pawl 16, as well as each of the other components, can each have many different configurations and can be formed of many different materials. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A recliner mechanism comprising, in combination:
a base housing adapted to be held to a seat cushion frame;
a sector housing adapted to be held to a seat back frame;
wherein said sector housing is rotatable relative to the base housing about a pivot axis and has a plurality of teeth;
a locking pawl having a plurality of teeth engageable with the teeth of the sector housing;
wherein the locking pawl is movable between a locking position with the teeth of the locking pawl engaging the teeth of the sector housing to prevent rotatable movement of the sector housing relative to the base housing and a releasing position with the teeth of the locking pawl disengaged from the teeth of the sector housing to permit rotatable movement of the sector housing relative to the base housing; and
a cam rotatable about the pivot axis and rotatably connected to the locking pawl about an eccentric axis to move the locking pawl between the locking position and the releasing position in response to rotation of the cam about the pivot axis.

2. The recliner mechanism according to claim 1, wherein the eccentric axis is parallel to and spaced apart from the pivot axis.

3. The recliner mechanism according to claim 1, further comprising at least one spring member resiliently biasing the cam to move the locking pawl to the locking position.

4. The recliner mechanism according to claim 3, wherein there are a pair of spring members resiliently biasing the cam to move the locking pawl to the locking position and acting on opposite sides of the cam.

5. The recliner mechanism according to claim 1, wherein the cam moves the eccentric axis of the locking pawl along an arc about the pivot axis.

6. The recliner mechanism according to claim 1, wherein the pivotable connection between the cam and the locking pawl includes an opening formed in the locking pawl and closely receiving a cylindrically shaped-camming surface of the cam formed about the eccentric axis.

7. The recliner mechanism according to claim 1, wherein the plurality of teeth of the sector housing are internal teeth.

8. The recliner mechanism according to claim 1, wherein the plurality of teeth of the sector housing have a maximum spacing of 1.5 degrees.

9. The recliner mechanism according to claim 1, further comprising a plurality of guides through which the locking pawl extends to guide motion of the locking pawl between the locking position and the releasing position.

10. A recliner mechanism comprising, in combination:
a base housing adapted to be held to a seat cushion frame;
a sector housing adapted to be held to a seat back frame;
wherein said sector housing is rotatable relative to the base housing about a pivot axis and has a plurality of teeth;
a locking pawl having a plurality of teeth engageable with the teeth of the sector housing;
wherein the locking pawl is movable between a locking position with the teeth of the locking pawl engaging the teeth of the sector housing to prevent rotatable movement of the sector housing relative to the base housing and a releasing position with the teeth of the locking pawl disengaged from the teeth of the sector housing to permit rotatable movement of the sector housing relative to the base housing;
a cam rotatable about the pivot axis and operably connected to the locking pawl to move the locking pawl between the locking position and the releasing position in response to rotation of the cam about the pivot axis; and
wherein the cam moves a lateral axis of the locking pawl along an arc about the pivot axis.

11. The recliner mechanism according to claim 10, wherein the cam is rotatably connected to the locking pawl about the lateral axis which is eccentric to the pivot axis to move the locking pawl between the locking position and the releasing position in response to rotation of the cam about the pivot axis.

12. The recliner mechanism according to claim 11, wherein the pivotable connection between the cam and the locking pawl includes an opening formed in the locking pawl and closely receiving a cylindrically shaped-camming surface of the cam formed about the eccentric axis.

13. The recliner mechanism according to claim 11, wherein the lateral axis is parallel to and spaced apart from the pivot axis.

14. The recliner mechanism according to claim 11, further comprising at least one spring member resiliently biasing the cam to move the locking pawl to the locking position.

15. The recliner mechanism according to claim 14, wherein there are a pair of spring members resiliently biasing the cam to move the locking pawl to the locking position and acting on opposite sides of the cam.

16. The recliner mechanism according to claim 11, wherein the plurality of teeth of the sector housing are internal teeth.

17. The recliner mechanism according to claim 11, wherein the plurality of teeth of the sector housing have a maximum spacing of 1.5 degrees.

18. The recliner mechanism according to claim 11, further comprising a plurality of guides through which the locking pawl extends to guide motion of the locking pawl between the locking position and the releasing position.

19. A recliner mechanism comprising, in combination:
a base housing adapted to be held to a seat cushion frame;
a sector housing adapted to be held to a seat back frame;
wherein said sector housing is rotatable relative to the base housing about a pivot axis and has a plurality of teeth;
a locking pawl having a plurality of teeth engageable with the teeth of the sector housing;
wherein the locking pawl is movable between a locking position with the teeth of the locking pawl engaging the teeth of the sector housing to prevent rotatable movement of the sector housing relative to the base housing and a releasing position with the teeth of the locking pawl disengaged from the teeth of the sector housing to permit rotatable movement of the sector housing relative to the base housing;
a cam rotatable about the pivot axis and operably connected to the locking pawl to move the locking pawl between the locking position and the releasing position in response to rotation of the cam about the pivot axis;
wherein the base housing is provided with a boss located about the pivot axis; and
wherein the cam is provided with a recess closely receiving the boss to transfer loads from the cam to the base housing.

20. The recliner mechanism according to claim 19, wherein the boss is tubular-shaped.

21. The recliner mechanism according to claim 19, wherein the cam is rotatably connected to the locking pawl about an eccentric axis to move the locking pawl between the locking position and the releasing position in response to rotation of the cam about the pivot axis.

22. The recliner mechanism according to claim 21, wherein the eccentric axis is parallel to and spaced apart from the pivot axis.

23. The recliner mechanism according to claim 21, wherein the cam moves the eccentric axis of the locking pawl along an arc about the pivot axis.

24. The recliner mechanism according to claim 21, wherein the pivotable connection between the cam and the locking pawl includes an opening formed in the locking pawl and closely receiving a cylindrically shaped-camming surface of the cam formed about the eccentric axis.

25. The recliner mechanism according to claim 19, further comprising at least one spring member resiliently biasing the cam to move the locking pawl to the locking position.

26. The recliner mechanism according to claim 25, wherein there are a pair of spring members resiliently biasing the cam to move the locking pawl to the locking position and acting on opposite sides of the cam.

27. The recliner mechanism according to claim 19, wherein the plurality of teeth of the sector housing are internal teeth.

28. The recliner mechanism according to claim 19, wherein the plurality of teeth of the sector housing have a maximum spacing of 1.5 degrees.

29. The recliner mechanism according to claim 19, further comprising a plurality of guides through which the locking pawl extends to guide motion of the locking pawl between the locking position and the releasing position.
